(19) United States
(12) Patent Application Publication
(10) Pub. No.: US 2010/0199813 A1
(43) Pub. Date: Aug. 12, 2010

(54) Torque Wrenches for Coaxial Patch Cords and Related Assemblies and Methods

(76) Inventors: Neil Patrick Phillips, Dove Canyon, CA (US); Robert Ryan Riggsby, Hickory, NC (US)

Correspondence Address: MYERS BIGEL SIBLEY & SAJOVEC, P.O. BOX 37428, RALEIGH, NC, 27612, US

(21) Appl. No.: 12/580,545

(22) Filed: Oct. 16, 2009

Related U.S. Application Data
(60) Provisional application No. 61/151,657, filed on Feb. 11, 2009.

(51) Int. Cl. B25B 25/00; B25B 13/50

(52) U.S. Cl. 81/124.2; 29/747; 29/825; 29/758

(57) ABSTRACT

Torque wrenches for coaxial cable patch cords are provided that include a body having an outer surface, a first end, a second end and an internal bore extending from the first end to the second end. The internal bore has a first hexagonal cross-section at the first end and a second hexagonal cross-section at the second end. The first hexagonal cross-section is offset from the second hexagonal cross-section.

### CLAIM OF PRIORITY

The present application claims priority under 35 U.S.C. §119(e) to U.S. Provisional Patent Application Ser. No. 61/151,657, filed on Feb. 11, 2009, the entire content of which is incorporated herein by reference as if set forth in its entirety.

### FIELD OF THE INVENTION

The present invention relates generally to coaxial cable patch cords and, more particularly, to torque wrenches for such patch cords and related methods.

### BACKGROUND

Coaxial cables are a specific type of electrical cable that may be used to carry information signals such as television and data signals. Coaxial cables are widely used in cable television networks to provide broadband Internet connectivity. A typical coaxial cable has a core that comprises a central conductor that is surrounded by a dielectric, a foil tape and a braid. Electrical shielding braid wires, foil tape and a cable jacket surround the core.

Coaxial cables are typically terminated with a male coaxial connector that may be used to connect the coaxial cable to a female coaxial connector port that is mounted on, for example, a wall jack or on an appliance such as, for example, a television, a DVD player, a cable modem, etc. These male coaxial connectors are attached to the end of a coaxial cable using various cable preparation techniques and installation tools. One well known type of male coaxial connector is the coaxial “F-style” connector. A coaxial cable that has at least one end thereof terminated with a male coaxial connector such as an F-style coaxial connector is referred to herein as a “coaxial patch cord.”

FIGS. 1A and 1B are perspective and longitudinal section views, respectively, of an exemplary F-style coaxial connector 10. As shown in FIGS. 1A-1B, the connector 10 includes a tubular connector body 20, a compression sleeve 30, an inner contact post 40 and an internally-threaded nut 50. The internally-threaded nut 50 typically includes an enlarged hex-shaped band 52 having flats that would ordinarily be engaged by an installation wrench when tightening nut 50 over a female connector port. A coaxial cable (not shown) is inserted into the connector body 20, the compression sleeve 30, and the inner contact post 40 (when the connector is oriented as shown in FIG. 1B, the coaxial cable is inserted into the right side of the connector 10). The core of the coaxial cable inserts axially into an inside diameter of the inner contact post 40, while the electrical shielding wires/tape and the cable jacket circumferentially surround the outer surface of the inner contact post 40. Once the cable is inserted into the connector 10, a compression tool (not shown) is used to axially insert the compression sleeve 30 further into the tubular connector body 20. The compression sleeve 30 directly decreases the radial gap spacing between the connector body 20 and the inner contact post 40 so as to radially impart a 360-degree circumferential compression force on the electrical shielding wires/tape and the cable jacket to firmly hold the end of the coaxial cable within the connector 10. When the connector 10 has been installed on the end of a coaxial cable, the center conductor of the cable extends into the interior of the internally-threaded nut 50.

Coaxial patch cords that are terminated with F-style coaxial connectors such as connector 10 are commonly used to attach televisions, DVD players, cable modems and the like to female coaxial connector ports that are mounted on wall jacks in homes, offices, apartment buildings and the like. FIG. 2 shows a typical installation where a coaxial patch cord 100 is used to electrically connect a female connector port 85 that is mounted on a wall plate 80 to a female connector port 95 on a television set 90. As shown in FIG. 2, the patch cord 100 comprises a coaxial cable 110 that has an F-style coaxial connector 10 terminated on each end thereof. The coaxial cable 110 includes a central conductor 112 that extends into the internally-threaded nut 50 of each connector 10.

To electrically connect the television 90 to a coaxial cable 120 that is attached to the back end of the female connector port 85 mounted on the wall plate 80, an installer first inserts the central conductor 112 on the first end of the coaxial cable into the female connector port 85, and then threads the internally threaded nut 50 of the F-style connector 10 on the first end of the coaxial cable 110 onto the matching external threads of the female connector port 85. The installer then inserts the central conductor 112 on the second end of the coaxial cable 110 into the female connector port 95 of television set 90, and then threads the internally-threaded nut 50 of the F-style connector 10 on the second end of the coaxial cable 110 onto the matching external threads of the female connector port 95 to complete the connection.

In order to ensure that a high quality electrical signal is transferred over the patch cord 100, it is necessary to firmly tighten each of the coaxial connectors 10 onto their respective female connector ports 85, 95. Typically a torque of 20 to 30 inch-pounds should be applied to the nut 50 of each connector 10 to provide a good electrical connection and to provide a mechanical connection that will resist loosening in response to forces that may be applied to the patch cord 100 when, for example, the television set is moved, rotated, etc. Typically, when hand-tightened, a torque of only about 2 to 4 inch-pounds can be applied to the nut 50 of a typical coaxial connector 10. Thus, installers or consumers may use a wrench to more firmly tighten each coaxial connector of a coaxial patch cord to its respective female connector port.

Unfortunately, however, the female coaxial connector ports that are incorporated on television sets, DVD players and the like can be somewhat fragile in that they can only withstand a certain amount of rotational torque such as, for example, a torque of 30-50 inch-pounds. Due to the risk of damaging such expensive electronic equipment, installers in the field may be hesitant to use a wrench to tighten a coaxial cable connector onto a female connector port of such equipment. Additionally, consumers often disconnect coaxial cables from equipment when relocating such equipment, but consumers are not adequately trained or equipped to properly reconnect such coaxial connectors to the equipment ports following such relocation. As a result, in either of the above cases, the coaxial connectors may not be adequately tightened to the female connector port, which can result in a poor electrical connection.

### SUMMARY

Pursuant to embodiments of the present invention, dual-ended torque wrenches for coaxial connectors are provided that include a body (e.g., a tubular body) having an outer surface, a first end, a second end and an internal bore extending from the first end to the second end. The internal bore has a first hexagonal cross-section at the first end and a second hexagonal cross-section at the second end. The first hexagonal cross-section is offset from the second hexagonal cross-section.

In some embodiments, a middle portion of the outer surface of the tubular body has a larger diameter than a diameter of the first end of the outer surface of the tubular body. The outer surface of the tubular body may include a plurality of grooves such as, for example, generally longitudinally extending grooves. The outer surface of the tubular body may include at least one labeling surface. The first hexagonal cross-section may be rotationally offset from the second hexagonal cross-section. In some embodiments, the rotational offset may be between about 20 degrees to about 40 degrees. In some embodiments, the tubular body may be a two piece tubular body that includes a first body piece and a second body piece. The first body piece may include a projection and the second body piece may include a receptacle that is configured to receive the projection. The first body piece may be in snap engagement with the second body piece. The first and second body pieces may be substantially identical in some embodiments. In some embodiments, the tubular body may be a one piece tubular body that includes a hinge. In some embodiments, a central portion of the internal bore may have a third cross-section that differs from the first and second hexagonal cross-sections. The above-described dual-ended torque wrenches may be provided in combination with a patch cord having a coaxial connector terminated on each end thereof.

Pursuant to further embodiments of the present invention, torque wrenches for coaxial connectors are provided that include a body having an outer surface, a first end, a second end and an internal bore extending from the first end to the second end. The internal bore has a first hexagonal cross-section at the first end and a second hexagonal cross-section at the second end. A central portion of the internal bore has a third cross-section that is different from both the first hexagonal cross-section and the second hexagonal cross-section.

In some embodiments, the third cross-section may be a substantially circular cross-section. The diameter of the third cross-section may be at least substantially as large as the crown-to-crown diameter of the first hexagonal cross-section. A middle portion of the outer surface of the body may have a larger diameter than a diameter of the first end of the outer surface of the body. The outer surface of the body may include a plurality of generally longitudinally extending grooves. In some embodiments, the body may be a two piece tubular body that includes a first body piece having a projection and a second body piece having a receptacle that is configured to receive the projection. In other embodiments, the body is a one piece tubular body that may or may not include a hinge. The above-described torque wrenches may be provided in combination with a patch cord having a coaxial connector terminated on each end thereof.

### BRIEF DESCRIPTION OF THE DRAWINGS

FIG. 1A is a perspective view of a prior art coaxial F-style connector that has a compression style back fitting.

FIG. 1B is a longitudinal section view of the prior art coaxial F-style connector of FIG. 1A.

FIG. 2 is a schematic perspective view of a prior art coaxial patch cord that is used to electrically connect a television set to a female connector port on a wall outlet.

FIG. 3A is a side view of a dual-ended torque wrench according to certain embodiments of the present invention.

FIG. 3B is an end view of the dual-ended torque wrench of FIG. 3A.

FIG. 3C is a perspective view of the dual-ended torque wrench of FIG. 3A.

FIG. 3D is a perspective view of the dual-ended torque wrench of FIG. 3A.

FIG. 3E is a perspective view of a modified version of the dual-ended torque wrench of FIG. 3A.

FIG. 4A is a side view of a dual-ended torque wrench according to further embodiments of the present invention.

FIG. 4B is a longitudinal section view of the dual-ended torque wrench of FIG. 4A.

FIG. 4C is an end view of the dual-ended torque wrench of FIG. 4A.

FIG. 4D is a perspective view of the dual-ended torque wrench of FIG. 4A.

FIG. 4E is a simplified and enlarged end view of the dual-ended torque wrench of FIG. 4A.

FIG. 4F is a simplified longitudinal section view taken through opposing crowns of the hexagonal bore of the dual-ended torque wrench of FIG. 4A.

FIG. 5A is a side view of a dual-ended torque wrench according to still further embodiments of the present invention.

FIG. 5B is an end view of the dual-ended torque wrench of FIG. 5A.

FIG. 5C is a perspective view of the dual-ended torque wrench of FIG. 5A.

FIG. 6A is a perspective view of a dual-ended torque wrench according to yet additional embodiments of the present invention.

FIG. 6B is a simplified longitudinal section view of the dual-ended torque wrench of FIG. 6A.

FIG. 7A is a perspective view of a dual-ended torque wrench according to still further embodiments of the present invention.

FIG. 7B is a longitudinal section view of the dual-ended torque wrench of FIG. 7A.

FIG. 7C is a simplified end view of the dual-ended torque wrench of FIG. 7A.

FIG. 8A is a simplified end view of a modified version of the dual-ended torque wrench of FIG. 7A.

FIG. 8B is a simplified longitudinal section view of the hexagonal bore of the dual-ended torque wrench of FIG. 8A.

FIG. 8C is a simplified end view illustrating another modified version of the dual-ended torque wrench of FIG. 7A.

FIG. 9 is a perspective view of a hinged dual-ended torque wrench according to still further embodiments of the present invention.

FIG. 10 is a perspective view of a two-piece dual-ended torque wrench according to yet additional embodiments of the present invention.

FIG. 11 is a perspective view of a modified version of the two-piece dual-ended torque wrench of FIG. 10.

FIG. 12 is a side view of a dual-ended torque wrench illustrating how instruction boxes may be included on the exterior surface of the dual-ended torque wrenches according to embodiments of the present invention.

FIG. 13 is a schematic diagram illustrating an assembly comprising a coaxial patch cord and a dual-ended torque wrench according to embodiments of the present invention.

FIG. 14 is a side view of a dual-ended torque wrench according to embodiments of the present invention being used to attach a coaxial connector of a coaxial patch cord to a recessed female connector port on an electronic device.

FIG. 15 is a flow chart of a method of installing a coaxial patch cord according to certain embodiments of the present invention.

FIG. 16 is a schematic cross-sectional diagram illustrating a mating post and cavity that may be used in the hinged and multi-piece torque wrenches according to embodiments of the present invention.

### DETAILED DESCRIPTION

The present invention is described more fully hereinafter with reference to the accompanying drawings, in which certain embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the size of lines and elements may be exaggerated for clarity. It will also be understood that when an element is referred to as being “coupled” to another element, it can be coupled directly to the other element, or intervening elements may also be present. In contrast, when an element is referred to as being “directly coupled” to another element, there are no intervening elements present. Likewise, it will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “front”, “rear” and the like are used herein for the purpose of explanation only.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items.

Pursuant to embodiments of the present invention, dual-ended torque wrenches for coaxial patch cords are provided that may be used to facilitate fastening (and unfastening) the coaxial connectors of the patch cord onto mating female coaxial connector ports. The torque wrenches according to embodiments of the present invention may allow an installer or consumer to tighten the coaxial connectors onto the mating female connector ports with a torque that is sufficient to provide a good mechanical and electrical connection, but which is not so large that it is likely to damage or destroy the female connector port.

The dual-ended torque wrenches according to embodiments of the present invention may include a wrench body having opposing ends. One or more hexagonal bores may be formed in opposing ends of the wrench body such that the wrench body is a hollow wrench body. The hexagonal bore(s) may be sized, for example, to fit the internally-threaded nut of a conventional F-style coaxial connector. These dual-ended torque wrenches can be assembled onto a coaxial cable of a coaxial patch cord to provide an assembly. The cable of the patch cord may extend through the hexagonal bore(s) in the wrench body so that the wrench is axially slidable along the cable from one connector to the other of the coaxial patch cord.

In some embodiments, the dual-ended torque wrenches may include an inner stop that prevents or discourages the torque wrench from sliding over a connector and off of the patch cord. The inner stop may be formed, for example, by rotationally offsetting two opposing hexagonal bores relative to a central axis of the hollow wrench body or by providing a circular inner bore between two opposing hexagonal bores that has a diameter that is less than the crown-to-crown diameter of the hexagonal bores.

In some embodiments, the dual-ended torque wrenches may include grooves, such as longitudinal grooves, knurled grooves, etc., in the outer surface thereof to improve the ability of an installer to grip the tool and apply increased force when using the wrench to tighten the nut of a coaxial connector. A region of the outer surface of the dual-ended torque wrenches according to embodiments of the present invention may also include an area having an increased diameter which may allow an installer or consumer to apply increased torque when tightening the nut of a coaxial connector onto a mating female connector port.

The dual-ended torque wrenches pursuant to embodiments of the present invention may be inexpensive to manufacture, and may allow the internally-threaded nut of the coaxial connectors to be more easily grasped and tightened. They may also avoid the need for an installer or consumer to use a traditional wrench to tighten the coaxial connector onto the female connector port. The dual ended torque wrench may also facilitate tightening the nut of a coaxial connector that is mated to a female connector port that is located in a recessed area, such as in a cut-out area on the back of a television set or DVD player. Some of the torque wrenches according to embodiments of the present invention may be configured so that they can be removed from a coaxial patch cord, whereas other embodiments may be permanently installed on the patch cord. Moreover, the dual ended torque wrenches according to embodiments of the present invention may be used to tighten both coaxial connectors of a standard coaxial patch cord by sliding the wrench along the patch cord from the connector on one end to the connector on the other end.

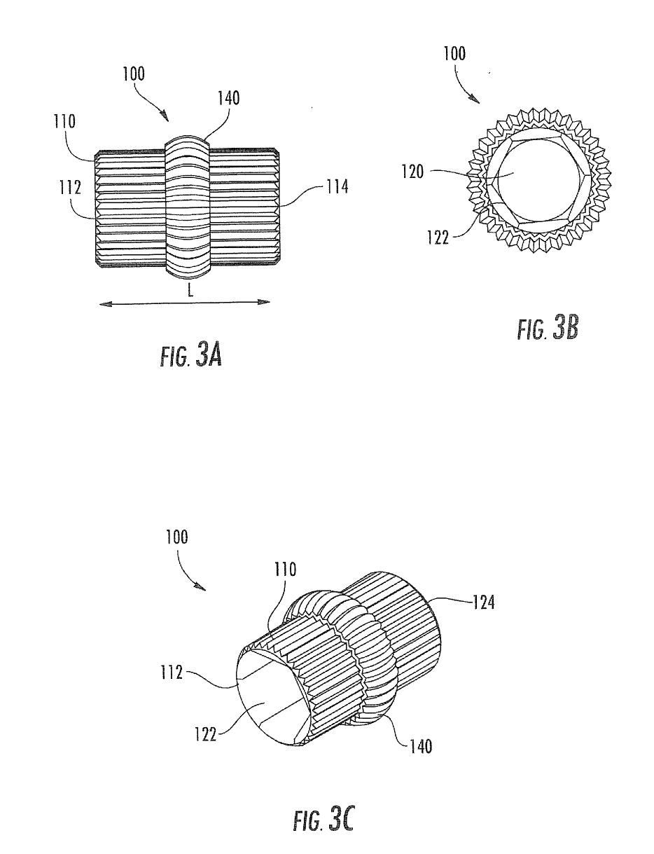

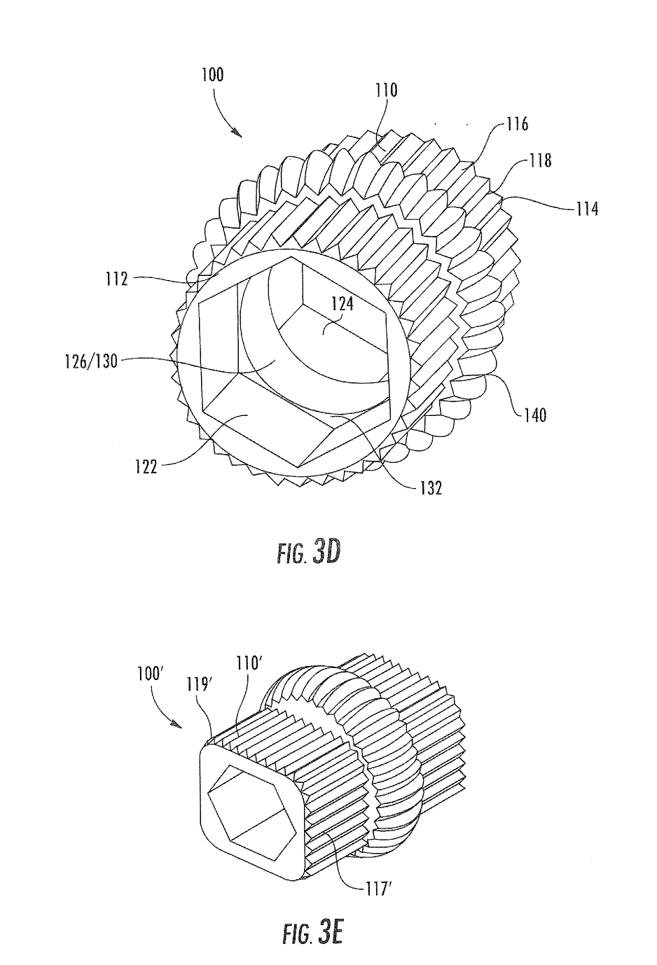

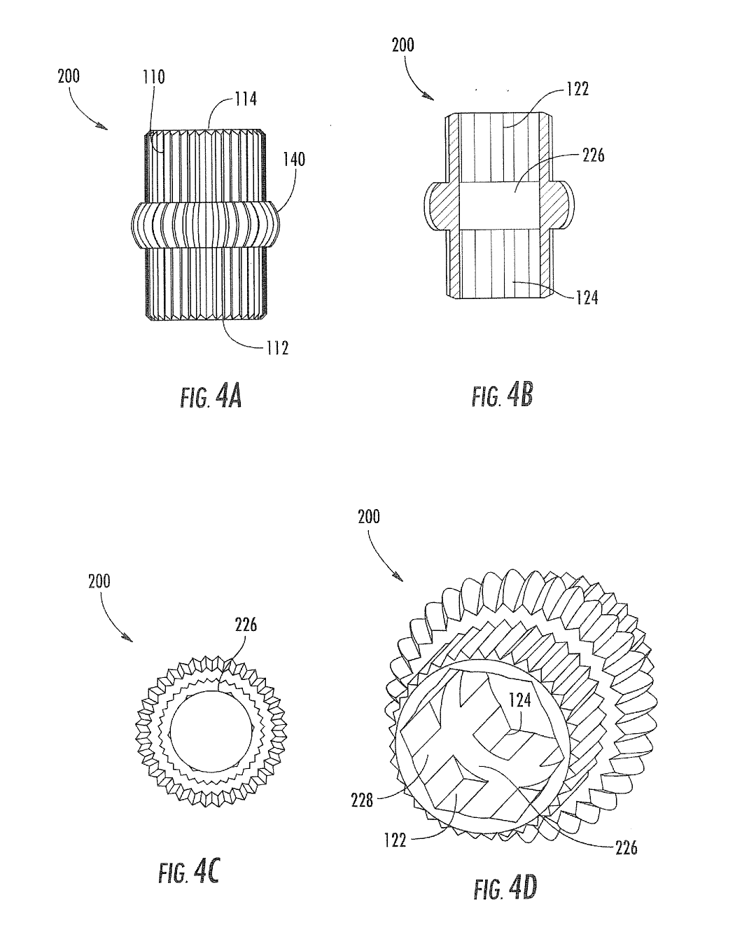

Turning now to the drawings, FIGS. 3A-3D illustrate a dual-ended torque wrench 100 according to certain embodiments of the present invention. In particular, FIG. 3A is a side view of a dual-ended torque wrench 100, FIG. 3B is an end view of the wrench 100, and FIGS. 3C and 3D are two perspective views of the wrench 100.

As shown in FIGS. 3A-3D, the dual-ended torque wrench 100 has a generally tubular hollow body 110 that has an inner bore 120 extending along the axial length thereof which is configured to receive a coaxial cable. The body 110 has an axial length L extending from a first end 112 to a second end 114. The axial length may exceed the axial length of the internally-threaded nut on typical F-style coaxial connectors. The inner bore 120 may comprise first and second hexagonal bores (i.e., a bore having a hexagonal cross-section) 122, 124 that are formed at respective ends 112, 114 of the body 110. The first and second hexagonal bores 122, 124 may be identical to each other. The first and second hexagonal bores 122, 124 may generally match the outer contour of the internally-threaded nut of a standard F-style coaxial connector. As shown in FIG. 3D, the hexagonal bores 122, 124 may extend into the body 110 by a distance that is less than half the length L of the body 110.

As shown best in FIGS. 3B and 3D, the torque wrench 100 may further include an inner stop 130 that may prevent the torque wrench 100 from sliding over a connector and off of a coaxial patch cord on which the torque wrench 100 is installed. In some embodiments, the inner stop 130 may comprise a circular inner bore 126 that is provided between the opposing hexagonal bores 122, 124. Thus, in some embodiments, the inner bore 120 may include hexagonal bores 122, 124 and a circular bore 126. In the embodiments of FIGS. 3A-3D, the circular inner bore 126 has a diameter that is approximately equal to a flat-to-flat diameter of the hexagonal inner bores 122, 124. Accordingly, the circular inner bore 126 defines a plurality of stops 132 that are located at the crowns of the hexagonal bores 122, 124. When the torque wrench 100 is installed on a coaxial patch cord and then is slid over a standard F-style coaxial connector that is on an end of the coaxial patch cord, the stops 132 engage the rear outer edge of the nut of the coaxial connector, thereby preventing the central region of the torque wrench 100 from sliding onto the nut. In this manner, the stops 132 may prevent the torque wrench 100 from sliding off of the coaxial patch cord.

As shown in FIGS. 3A-3D, the torque wrench 100 may include a plurality of longitudinal ridges 116 on the outer surface of the body 110 that define a plurality of longitudinal grooves 118. The longitudinal ridges and grooves 116, 118 may enhance the ability of an installer to grip and turn the wrench 100. While in the embodiments of FIGS. 3A-3D the longitudinal ridges and grooves 116, 118 are illustrated as straight grooves, it will be appreciated that in other embodiments the longitudinal ridges and grooves can have a different configuration, such as zig-zagged ridges/grooves or curved ridges/grooves that generally run in a longitudinal direction. In other embodiments, the outer surface of the body 110 can include a plurality of stubs, protruding dots and/or nipples. It will also be appreciated that more or fewer ridges, grooves or stubs could be provided, and/or that the size and/or spacing of the ridges and/or stubs could be varied.

The torque wrench 100 may further include a circumferential ring 140 that protrudes from an outer wall of the body 110 so as to increase the diameter of a central portion of the body 110. The circumferential ring 140 illustrated in FIGS. 3A-3D has a generally arcuate profile, viewed in the side view of FIG. 3A, for comfort and ease of use. By grasping the circumferential ring 140 that has the larger outer diameter, an installer can apply increased torque when tightening a nut using the torque wrench 100.

The torque wrenches disclosed herein may be formed of, for example, a plastic or thermoplastic material or any other rigid or semi-rigid material including metals and metal alloys. It may be molded, milled or machined to shape or formed using any other appropriate manufacturing technique. In some embodiments, the torque wrenches may be formed by injection molding of Delrin® thermoplastic resin, which is commercially available from DuPont Corporation.

The outer surface of the tubular hollow body 110 of connector 100 is generally cylindrical. However, it will be appreciated that, in other embodiments, the outer surface may be formed as a series of flattened surfaces that form in a hexagonal, octagonal or other shaped body 110, or may comprise a series of flattened surfaces that are joined to each other by rounded surface edge portions. Other configurations may also be used. FIG. 3E is a perspective view of a torque wrench 100′ that is similar to torque wrench 100, but the outer surface of the hollow body 110′ of wrench 100′ is formed as a series of four flat surfaces 117′ that are joined to each other by rounded surface edge portions 119′.

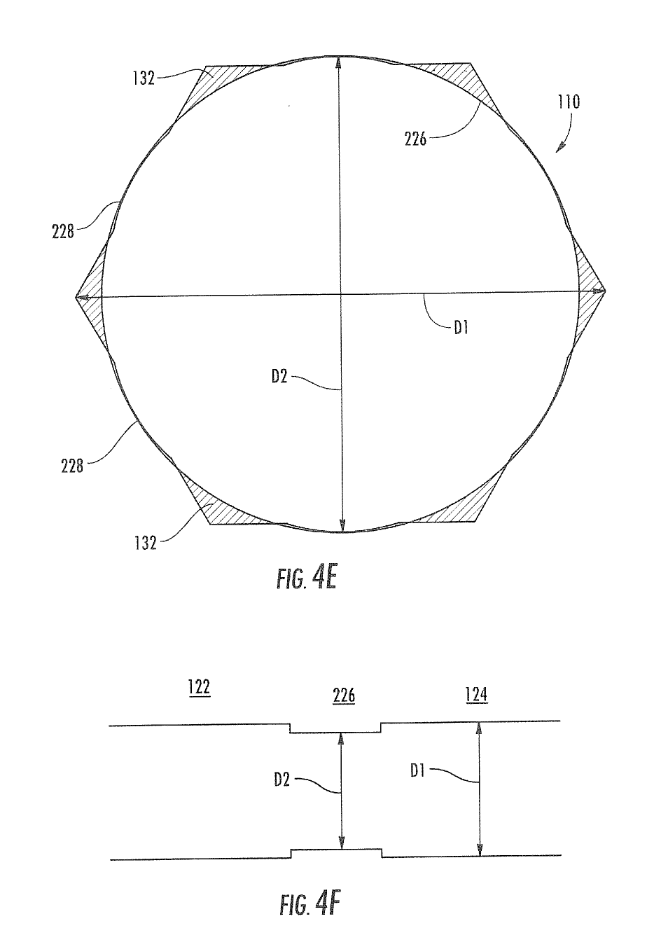

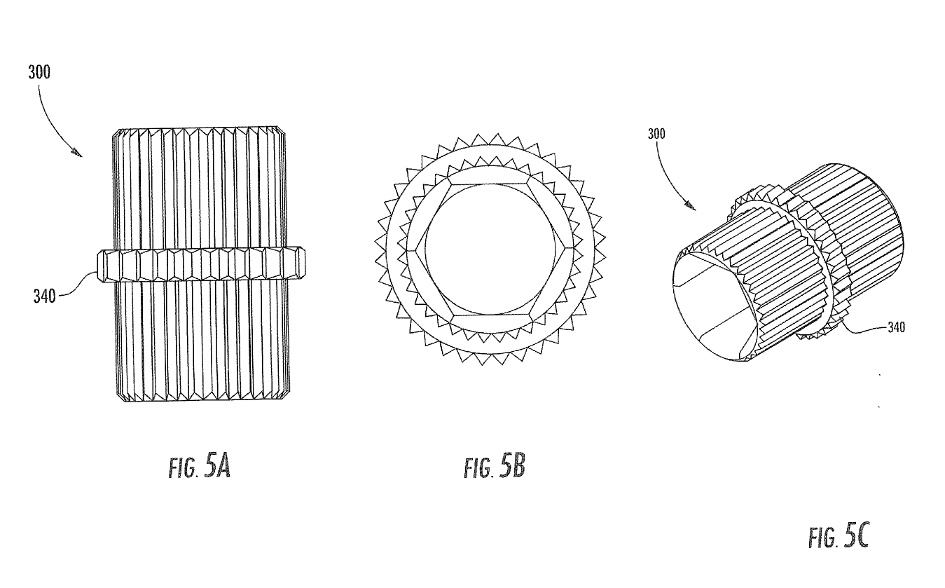

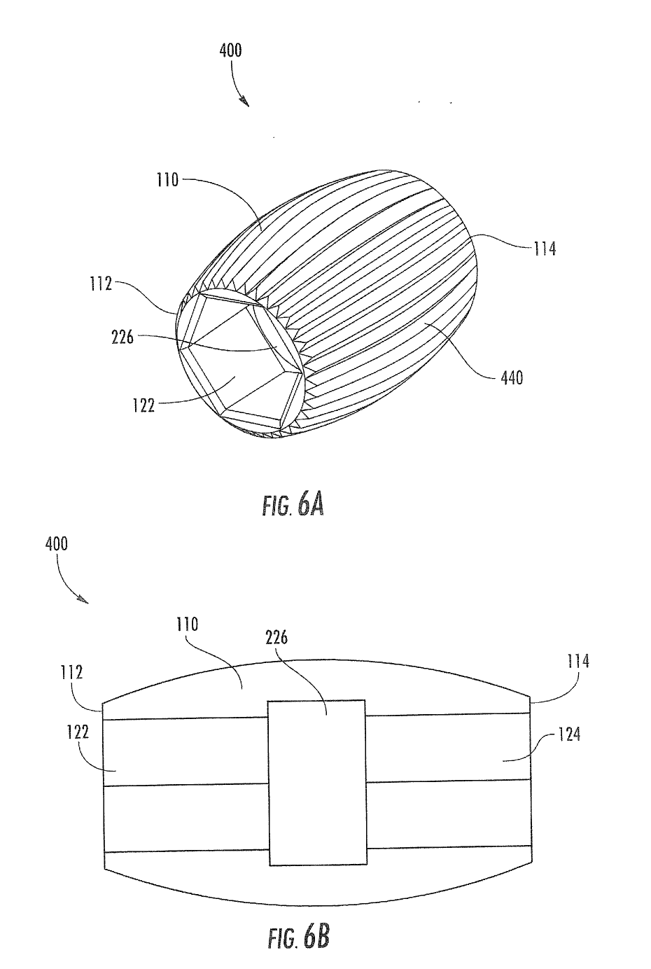

FIGS. 4A-4F depict a dual-ended torque wrench 200 according to further embodiments of the present invention. In particular, FIG. 4A is a side view of the wrench 200, FIG. 4B is a longitudinal section view of wrench 200, FIG. 4C is an end view of the wrench 200, and FIG. 4D is a perspective view of the wrench 200. FIGS. 4E and 4F are, respectively, a simplified and enlarged end view and a simplified longitudinal section view of the wrench 200.

As is apparent from FIGS. 4A-4F, torque wrench 200 is similar to torque wrench 100 described above. Accordingly, like elements of torque wrench 200 are numbered using the reference numbers of the corresponding elements of torque wrench 100, and these elements are not described further herein. However, in torque wrench 200, the circular inner bore 226 differs from the circular inner bore 126 of torque wrench 100 in that the inner bore 226 has a diameter that is greater than a flat-to-flat diameter of the hexagonal bores 122, 124, but less than the crown-to crown diameter of the hexagonal bores 122, 124. Additionally, the circular inner bore 226 extends from one end 112 to the other end 114 of the body 110 of the wrench 200, thereby defining arcuate indentions 228 in the flat surfaces of the hexagonal bores 122, 124.

FIG. 4E illustrates the shape of the inner wall of the body 110 when viewed from an end 112, 114 that more clearly illustrates the arcuate indentions 228 in the flat surfaces of the hexagonal bores 122, 124, as well as the stops 132 defined by the circular inner bore 226. FIG. 4F illustrates a longitudinal cross-section of the inner wall of the body 110 that is taken through opposing crowns of the hexagonal bores 122, 124. As shown in FIG. 4F, the interior width of the body 110 is equal to the crown-to-crown diameter D1 of the hexagonal bores 122, 124 near the ends 112, 114 of the body 110, and reduces down to the diameter D2 of the circular inner bore 226 at the center of the body 110.

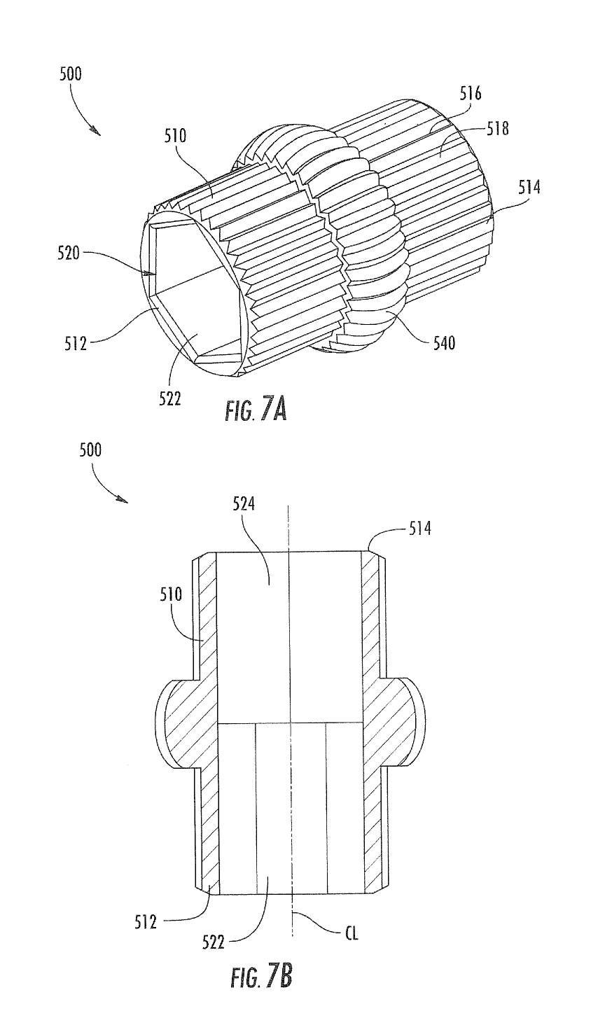

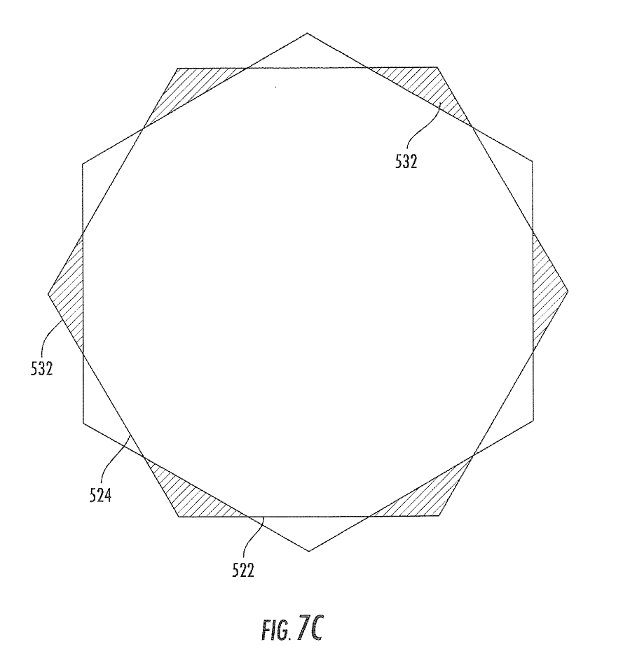

FIGS. 5A-5C illustrate a dual-ended torque wrench 300 according to still further embodiments of the present invention. In particular, FIGS. 5A-5C are a side view, an end view and a perspective view, respectively, of the dual-ended torque wrench 300.

The torque wrench 300 is almost identical to torque wrench 100 described above. Accordingly, like elements of torque wrench 300 are numbered using the reference numbers of the corresponding elements of torque wrench 100, and these elements are not described further herein. However, with the torque wrench 300, the circumferential ring 140 of wrench 100 is replaced with a circumferential ring 340 that has a smaller axial length and has a flat profile when viewed in the side view of FIG. 5A as opposed to the arcuate profile of the circumferential ring 140 of wrench 100.

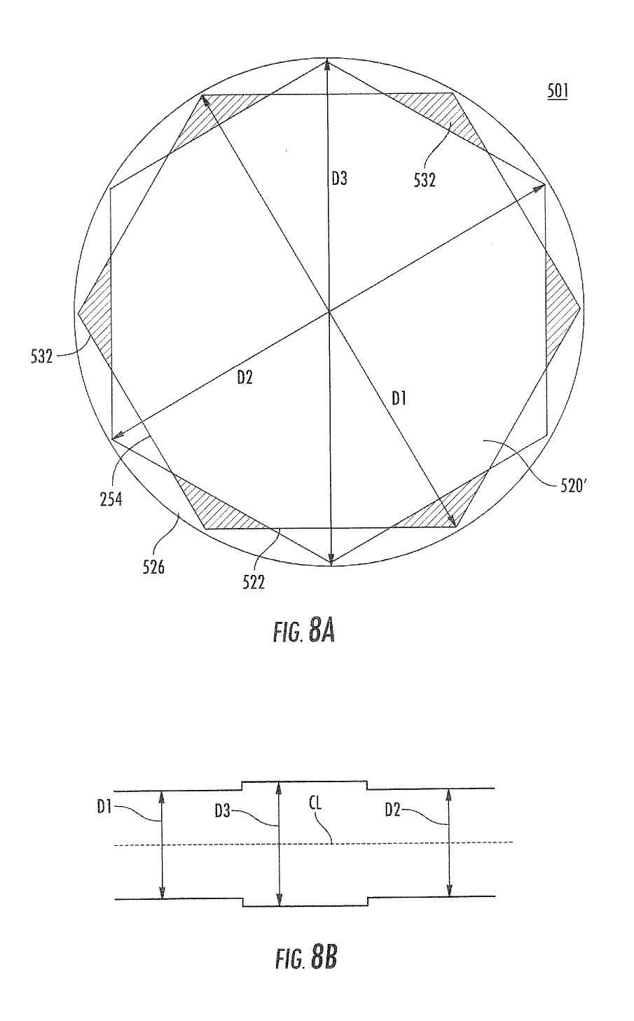

FIGS. 6A-6B illustrate a dual-ended torque wrench 400 according to still further embodiments of the present invention. In particular, FIG. 6A is a perspective view of a dual-ended torque wrench 400, and FIG. 6B is a longitudinal section view of the wrench 400.

The torque wrench 400 is similar to torque wrench 100 described above. Accordingly, like elements of torque wrench 400 are numbered using the reference numbers of the corresponding elements of torque wrench 100, and these elements are not described further herein. However, the outer surface of the body 110 of torque wrench 400 comprises a circumferential ring 440 that has a generally convex shape, and the ring 440 extends from one end 112 to the other end 114 of wrench 400. Thus, the outer surface of the wrench 400 has a larger outer diameter near the center of the wrench 400 than near the ends 112, 114. The sectional view of FIG. 6B is taken along a flat-to-flat diameter of the hexagonal bores 122, 124. Accordingly, the inner bore 226 has a larger diameter than the flat-to-flat diameter of the hexagonal bores 122, 124, as is the case with the torque wrench 200 described above with respect to FIGS. 4A-4F.

FIGS. 7A-7C illustrate a dual-ended torque wrench 500 according to still farther embodiments of the present invention. In particular, FIGS. 7A and 7B are a perspective view and a longitudinal section view, respectively, of the wrench 500, and FIG. 7C is a simplified, schematic end view of the wrench 500 that illustrates the rotational offset between first and second hexagonal bores of the wrench 500.

As shown in FIGS. 7A and 7B, the wrench 500 has a generally tubular hollow body 510 that has a first end 512 and a second end 514. An inner bore 520 extends through the axial length of the body 510, and comprises a first hexagonal bore 522 and a second hexagonal bore 524, each of which may generally match the outer contour of the internally-threaded nut of a standard F-style coaxial connector. As shown in FIG. 7B, the hexagonal bores 522, 524 may each extend into the body 510 by a distance of L/2 where L is the axial length of the body 510.

The torque wrench 500 does not include a separate inner stop such as the inner stop 130 of the torque wrench 100 of FIGS. 3A-3D. Instead, in the torque wrench 500, the first and second hexagonal bores 522, 524 are rotationally offset relative to an imaginary centerline CL running longitudinally through the wrench 500, and hence are rotationally offset from each other. Accordingly, in some embodiments, the wrench 500 includes a first hexagonal bore 522 at a first end 512 and a second hexagonal bore 524 at the opposite end 514 that is in communication with the first hexagonal bore 522 so that the cable of a patch cord can extend through the wrench 500 from one end to the other. In some embodiments, the first hexagonal bore 522 may be rotationally offset from the second hexagonal bore 524 by between about 20 degrees and about 40 degrees. In one specific embodiment, the first hexagonal bore 522 may be rotationally offset from the second hexagonal bore 524 by about 1/12 of a rotation, or about 30 degrees, so that crowns of the first hexagonal bore 522 are aligned with the centerline of the flats of the second hexagonal bore 524, and vice versa.

As shown in FIG. 7C, the rotational offset between the first and second hexagonal bores 522, 524 creates a plurality of stops 532 in the center of the internal bore 520. These stops 532 prevent the torque wrench from sliding over a connector and off of a patch cord on which the torque wrench 500 is installed.

As shown in FIG. 7A, the outer surface of the body of torque wrench 500 includes a plurality of longitudinal ridges 516 that define a plurality of longitudinal grooves 518. The longitudinal ridges and grooves 516, 518 may enhance the ability of an installer to grip and turn the wrench 500. The torque wrench 500 further includes a circumferential ring 540 that has an arcuate profile that protrudes from the body so as to increase the diameter of a central portion of the body.

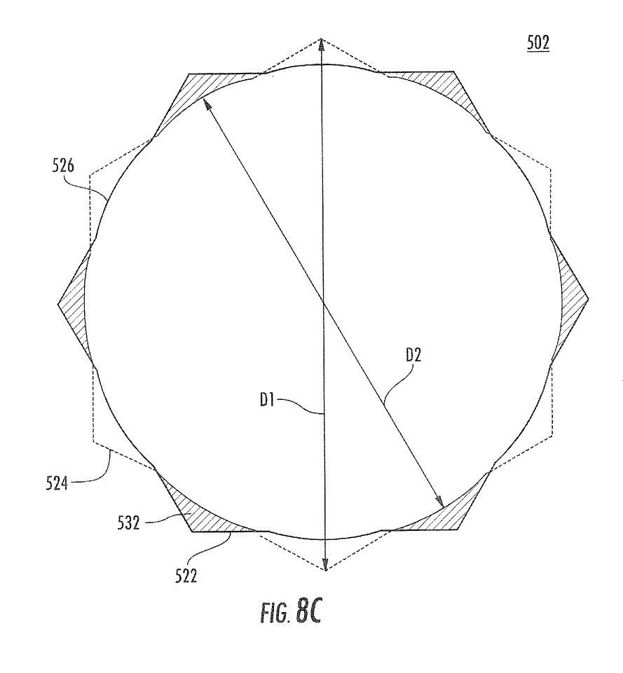

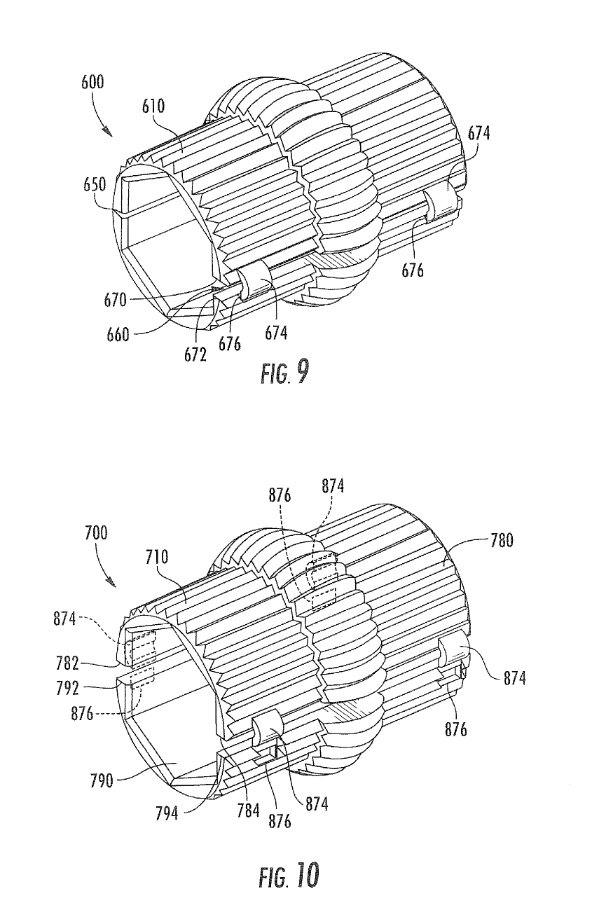

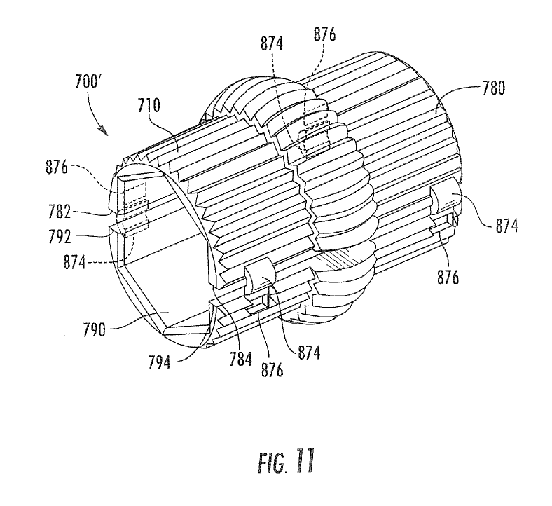

FIGS. 8A and 8B illustrate a modified version 501 of the torque wrench 500. In particular, FIG. 8A is a simplified, schematic end view of the torque wrench 501 that illustrates the rotational offset between first and second hexagonal bores of the wrench 501 and FIG. 8B is a simplified longitudinal section view of the torque wrench 501.

The torque wrench 501 differs from the torque wrench 500 in that the inner bore 520′ of torque wrench 501 includes a circular inner bore 526 having a diameter of D3 in addition to the first and second rotationally offset hexagonal bores 522, 524. The circular inner bore 526 is provided between the opposing hexagonal bores 522, 524. As shown in the schematic view of FIG. 8A, the circular inner bore 526 has a diameter that exceeds the crown-to-crown diameter of the hexagonal inner bores 522, 524. Moreover, the circular inner bore 526 has an axial length that exceeds the axial length of the nut on a standard F-style coaxial connector. Thus, when the torque wrench 501 is slid over a standard F-style coaxial connector, the nut on the connector may pass through the first hexagonal bore 522 and the inner circular bore 526, but then engages the stops 532, which are formed at the interface of the circular inner bore 526 and the second hexagonal bore 524, since the nut on the connector must be aligned with the first hexagonal bore 522 in order to pass through the first hexagonal bore 522 and into the circular inner bore 526. The stops 532 thus discourage the wrench 501 from accidentally falling off of the patch cord on which it is mounted. However, if a user wishes to remove the wrench 501 from the patch cord, at the point where the nut is received within the circular inner bore 526, the user can rotate the wrench 501 so that the crowns on the nut are aligned with the crowns on the second hexagonal bore 524. Once aligned, the user can pull the wrench 501 the rest of the way over the connector to fully remove the wrench 501 from the patch cord. This rotation of the wrench 501 is possible due to the provision of the inner circular bore 526 that has an axial length that exceeds the axial length of a standard connector nut and a diameter that is sufficient to allow for rotation over the nut. Thus, the torque wrench 501 can be installed and uninstalled from the cable of a patch cord by aligning the first hexagonal bore 522 over the nut, sliding the torque wrench 501 over the connector so that the nut passes into the inner circular bore 526, rotating the torque wrench 501 so that the second hexagonal bore 524 is aligned with the nut, and continuing to slide the torque wrench 501 over the connector and on to or off of the patch cord.

FIG. 8C is a simplified end view of a torque wrench 502 which is a modified version of the torque wrench 501. With torque wrench 502, the circular bore 526 may have a diameter D2 that is larger than a flat-to-flat diameter of the hexagonal bores 522, 524, but that is smaller than the crown-to-crown diameter D1 of the hexagonal bores 522, 524, so that arcuate indentions are formed in the flat surfaces of the hexagonal bores 522, 524. As such, the circular inner bore 526 forms the plurality of stops 532 as opposed to the second hexagonal bore 524. Unlike the wrench 501 discussed above, the wrench 502 cannot be slid over a connector and removed from a patch cord.

The above embodiments may each be implemented as a one piece torque wrench that is either installed on the patch cord at the time of manufacture, or which, in the case of wrench 501, may be inserted onto a patch cord by sliding the wrench (and rotating it, as necessary) over the connector on one end of the patch cord. Pursuant to additional embodiments of the present invention, one-piece and multi-piece torque wrenches are provided that can be snapped onto a central portion of a coaxial patch cord.

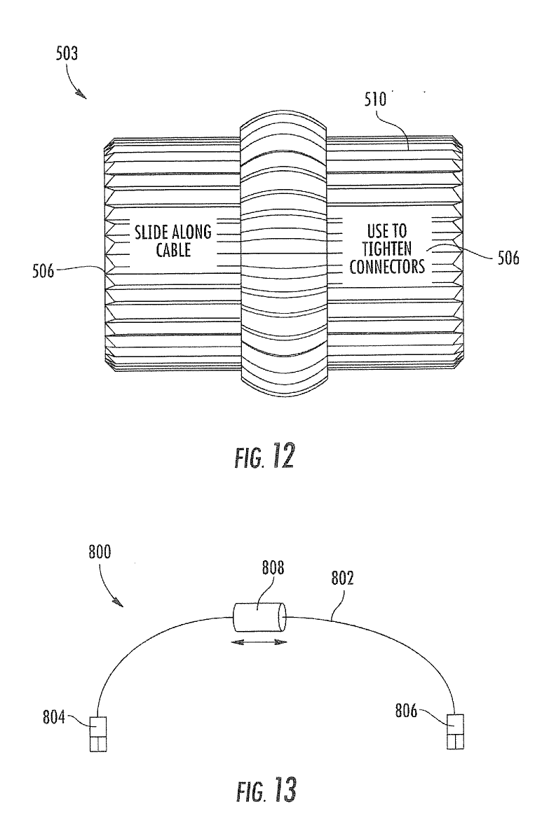

FIG. 9 is a perspective view of a hinged, one-piece dual-ended torque wrench 600 according to still further embodiments of the present invention. The torque wrench 600 shown in FIG. 9 may be nearly identical to the torque wrench 500 described above, except that the wrench body is formed as a hinged body 610. In particular, as shown in FIG. 9, the wall that forms the body 610 has a narrowed area 650 that is pliable and hence acts as a living hinge. The body 610 of wrench 600 is slit longitudinally opposite the narrowed area 650 to provide a gap 660 that is defined between first and second edges 670, 672 of body 610. An installer can enlarge the gap 660 by pulling the first and second edges 670, 672 further apart, which is facilitated by the narrowed area 650 which acts as a hinge, and may then insert the wrench 600 onto a coaxial cable. The first edge 670 includes a pair of projections 674 and the second edge 672 includes a pair of receptacles 676 that are positioned to receive respective ones of the projections 674. Each projection mates with its respective receptacle in order to lock the first and second edges 670, 672 together so that the wrench 600 is locked onto the coaxial cable.

As shown in FIG. 9, in some embodiments, the projections 674 may comprise snap clips 674 that are mounted at the first edge 670 that mate with respective recesses in the body at the second edge 672. One or multiple projection/receptacle pairs 674, 676 may be provided, and the projections 674 can all be on one the first and second edges 670, 672 with the receptacles 676 on the other of the first and second edges 670, 672, or alternatively, at least one projection 674 and at least one receptacle 676 may be provided on each of the first and second edges 670, 672. The projections 674 and receptacles 676 may mate to form a permanent connection that cannot be unfastened without application of a force that is sufficient to damage the projection 674 and/or receptacle 676, or the projections 674 and receptacles 676 may form a latched connection that allows a user to readily install and uninstall the wrench 600 from a coaxial patch cord.

While the torque wrench 600 comprises a modified version of the torque wrench 500 that includes a living hinge, it will be appreciated that each of the other embodiments described herein may similarly be modified to include a living hinge.

While the torque wrench 600 of FIG. 9 uses snap clips and mating recesses as the projections 674 and receptacles 676, it will be appreciated that a wide variety of different projections 674 and receptacles 676 (or other securing elements) may be used. For example, as shown the schematic cross-sectional diagram of FIG. 16, each projection 674 on first edge 670 may comprise a post 900 having an enlarged conical head 902 at a distal end thereof, and each receptacle 676 on second edge 672 may comprise a recess 910 in the body 920 of the connector that includes a narrow passage 912 and an enlarged conical cavity 914. The enlarged conical head 902 of the post 900 may be forced through the narrow passage 912 due to the pliable, resilient nature of the material used to form the wrench to force the enlarged conical head 902 of post 900 into cavity 914. Once the head 902 of post 900 is within the cavity 914, the annular wall 906 formed by the base of the enlarged conical head abuts the wall 916 formed at the top of the cavity 914, which may discourage or prevent the post 900 from being withdrawn from the recess 910, thereby holding the two pieces of the wrench together. It will be appreciated that a wide variety of other projection and receptacle pairs (or other securing elements) may be used in each of the wrenches according to embodiments of the present invention disclosed herein.

FIG. 10 is a perspective view of a two-piece dual-ended torque wrench 700 according to yet additional embodiments of the present invention. The wrench 700 is similar to the wrench 600 described above, except that the narrowed area 650 that forms the living hinge is replaced with a second longitudinal slit that divides the wrench body 710 into a first piece 780 that includes first and second edges 782, 784, and a second piece 790 that likewise has first and second edges 792, 794. The first piece 780 may be mated to the second piece by a plurality of securing elements that are provided at the first and second edges 782, 784, 792, 794 of the first and second pieces 780, 790. The securing elements may comprise four snap clips 874 that are provided on edges of the first piece 780 and four recesses 876 that are provided adjacent edges of the second piece 790.

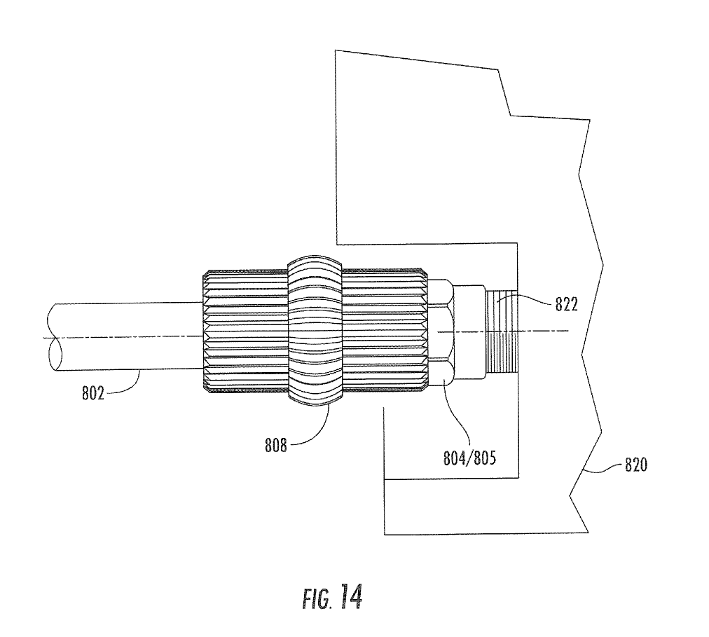

FIG. 11 is a perspective view of a torque wrench 700′ according to still further embodiments of the present invention. As shown in FIG. 11, the torque wrench 700′ is almost identical to the torque wrench 700 described above, except that two snap clips 874 and two recesses 876 may be provided on each of the first and second pieces 780, 790 (instead of providing four snap clips on one of the pieces and four recesses on the other piece) so that the first and second pieces may be identical. In this manner, a single mold may be used to manufacture both the first and second pieces 780, 790.

It will be appreciated that a wide variety of different securing elements could be used to secure the first piece 780 to the second piece 790 around a cable of a coaxial patch cord. It will also be appreciated that the securing elements could provide a permanent connection or a connection that can be undone and redone.

The torque wrenches 600, 700 and 700′ of FIGS. 9-11 may be advantageous in that they can be designed to include stop structures that prevent the wrench from fully sliding over and past the connectors on either end of a coaxial patch cord so that the wrench cannot inadvertently slide off of a coaxial patch cord. Moreover, to the extent that the securing elements provided thereon provide a connection that can be undone and redone, the wrenches 600, 700 and 700′ may still be removed from the patch cord if desired by an installer or consumer.

Pursuant to further embodiments of the present invention, any of the embodiments disclosed herein can be modified to include a labeling area on an outside surface thereof. By way of example, FIG. 12 illustrates a torque wrench 503 which is identical to torque wrench 500 of FIGS. 7A-7C above except that two labeling areas 506 are provided on an outside surface of the body 510 of wrench 503. These labeling areas 506 may comprise smooth areas that are suitable for printing and/or for molding text therein. As shown in FIG. 12, in some embodiments, the labeling area 506 may contain instructions that may assist installer and/or consumer in understanding proper use of the torque wrench. Examples of such instructions include “use to tighten connectors ” or “wrench” or “tightening tool.” These instructions may be particularly helpful for consumers who may not immediately recognize the purpose of the dual-ended torque wrenches according to embodiments of the present invention.

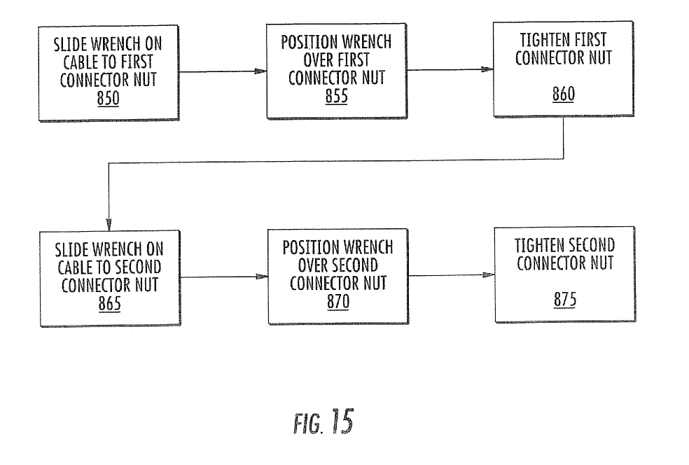

FIG. 13 is a schematic diagram illustrating an assembly comprising a coaxial patch cord and a dual-ended torque wrench according to embodiments of the present invention. As shown in FIG. 13, the assembly 800 includes a coaxial cable 802 that has a first coaxial connector 804 on a first end thereof and a second coaxial connector 806 on a second end thereof. The assembly 800 further includes a dual ended torque wrench 808 that is mounted on the cable 802 to be axially slideable along the cable 802 from the first connector 804 to the second connector 806. The dual-ended torque wrench is mounted on the cable 802 so that the cable 802 passes through the body of the wrench 808. The dual-ended torque wrench 808 may comprise, for example, any of the dual-ended torque wrenches disclosed herein. The wrench 808 can be used to tighten and or loosen the connectors 804, 806 onto mating female connector ports (not shown).

The wrenches according to embodiments of the present invention may also facilitate connecting patch cords to electronic devices which have recessed female connector ports as is often the case on, for example, flat screen televisions. In particular, FIG. 14 is a schematic diagram that illustrates how a dual-ended torque wrench 808 (which could be any of the torque wrenches disclosed herein) may be used to attach the connector 804 of the assembly 800 of FIG. 13 onto a recessed female connector port 822 of an electronic device 820.

Referring to FIG. 14, the installer may place the connector 804 on the female connector port 822, and may partially tighten the nut 805 of the connector 804 by hand. Wrench 808 may then be slid along the cable 802 of the patch cord 800 to the position illustrated in FIG. 14 where the nut 805 of connector 804 is received within a first end of the wrench 808. The installer may grasp and turn the outside surface of the body of wrench 808 in a clockwise direction in order to further tighten the nut 805 onto the connector port 822. The installer may grasp the circumferential ring of the wrench 808 when performing this tightening operation in order to obtain an increased mechanical advantage. It will be appreciated that the installer need not first hand-tighten the connector 804 onto the female connector port 822 prior to using the wrench 808. For example, the wrench 808 may be used in initially mating the connector 804 with the female connector port 822. As illustrated in FIG. 14, the torque wrench 808 effectively extends the axial length of the nut 805 of the connector 804 so that an installer need not reach his/her fingers into the recessed area in order to tighten the nut 805 onto the female coaxial connector port 822.

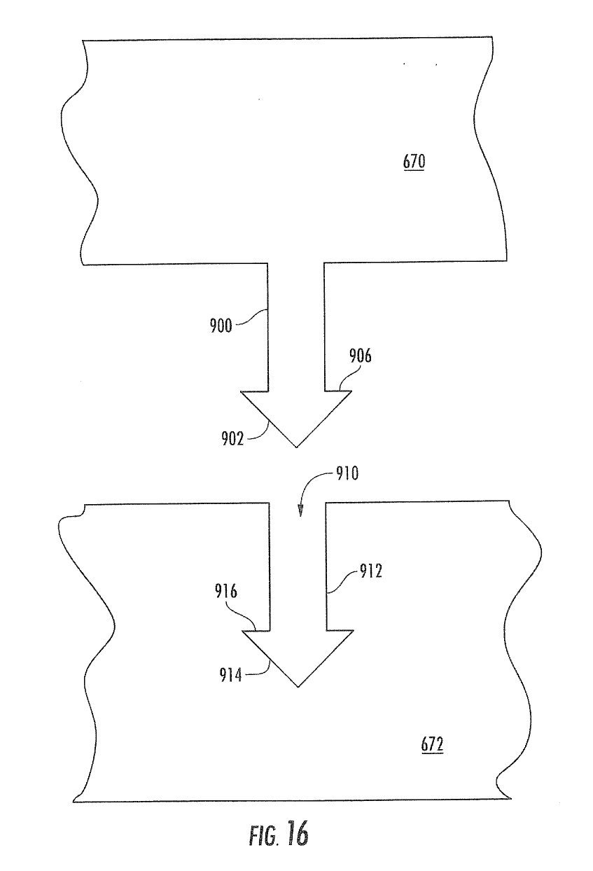

FIG. 15 is a flow chart of methods of installing a coaxial patch cord according to certain embodiments of the present invention. As shown in FIG. 15, operations may begin with an installer axially sliding a dual-ended torque wrench that is mounted on the coaxial cable segment of the patch cord along the coaxial cable segment to a first coaxial connector that is terminated on the first end of the patch cord (block 850). Next, the first end of the dual-ended torque wrench may be positioned over a nut of the first coaxial connector (block 855). The dual-ended torque wrench may then be used to tighten the nut of the first coaxial connector onto a first female connector port (block 860). The dual-ended torque wrench may then be slid axially along the coaxial cable segment to a second coaxial connector that is terminated on the second end of the patch cord (block 865). The second end of the dual-ended torque wrench may then be positioned over a nut of the second coaxial connector (block 870). The dual-ended torque wrench may then be used to tighten the nut of the second coaxial connector onto a second female connector port (block 875).

A dual-ended torque wrench having the design of the wrench 502 of FIG. 8C was manufactured and tested on a range of F-style coaxial connectors. A dial torque wrench was used to quantify the amount of force required to loosen each of the connectors after the connectors had been tightened using the torque wrench to its maximum amount. Three different technicians were used to tighten the connectors, to illustrate variation that might be expected based on installer strength. As a comparison, each of the technicians also tightened each of the F-style coaxial connectors by hand.

The tests showed that the torque levels on connectors that were tightened using the dual-ended torque wrench were 170% to 436% higher than the torque levels achieved by the same installers on the same connectors when the connectors were tightened by hand. Measured torque values ranged from 4.3 pounds to 12.3 pounds. The torque wrench was also used successfully to loosen each connector after tightening. These results show that the torque wrench may significantly increase the torque levels that an installer can achieve when installing an F-style coaxial connector on a mating female connector port as compared to the levels that can be achieved by finger tightening. While the actual torque levels will vary depending on connector design, finger strength, accessibility of the female connector port, etc., the test results do confirm that the torque wrenches according to embodiments of the present invention should allow installers to more firmly mate coaxial patch cords to female connector ports without the use of a standard wrench and without significant danger of damaging the female connector port.

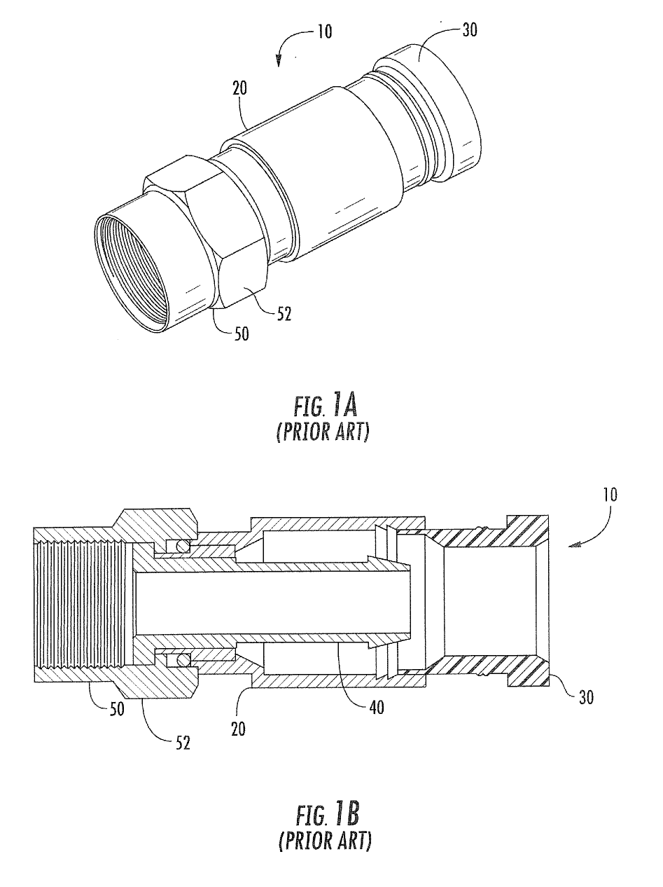

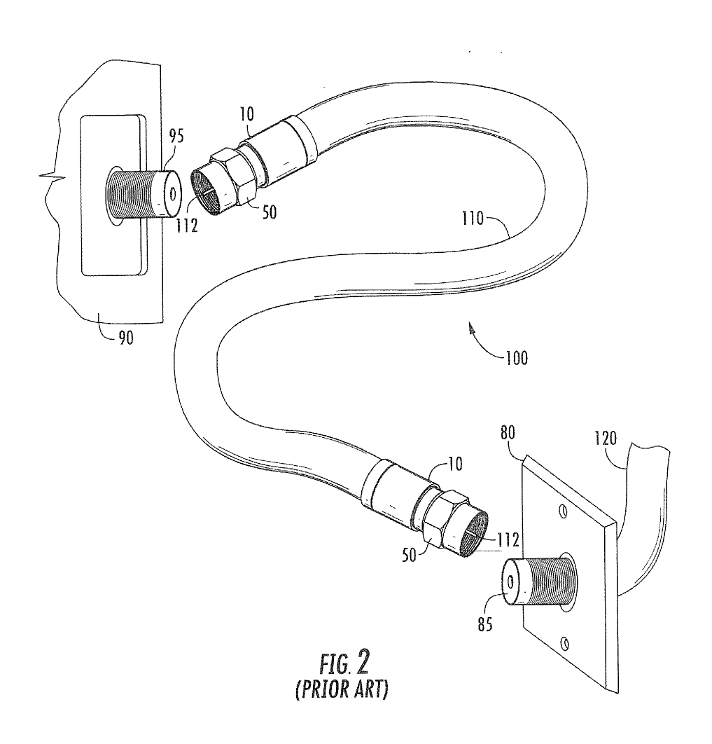

While one exemplary coaxial connector was discussed above with respect to FIGS. 1A and 1B, it will be appreciated that a wide variety of coaxial connectors are known in the art including, for example, coaxial connectors that are crimped or swaged onto the end of a coaxial cable and connectors which use compression elements to secure the coaxial cable within the connector body. It will be appreciated that the dual ended torque wrenches according to embodiments of the present invention may be used with any coaxial connectors that include a nut that is tightened onto a female connector port.

While a number of different embodiments of dual-ended torque wrenches have been described above, it will be appreciate that these embodiments are exemplary in nature, and that the present invention is not limited thereto. It will also be appreciated that these embodiments are provided to illustrate various features of the present invention, and that the features of the different embodiments may be combined in any fashion to provide a wide variety of different connectors that all fall within the scope of the present invention. By way of example, the circumferential rings 340 or 440 of wrenches 300 and 400, respectively, could be included on the wrenches 200 and 500 in place of the circumferential rings 140 and 540. Finally, it will also be appreciated that the torque wrenches disclosed herein may also be used as single-ended torque wrenches, and that therefore embodiments of the present invention may expand beyond dual-ended torque wrenches.

In the specification, there have been disclosed embodiments of the invention and, although specific terms are employed, they are used in a generic and descriptive sense only and not for purposes of limitation. The following claim is provided to ensure that the present application meets all statutory requirements as a priority application in all jurisdictions and shall not be construed as setting forth the scope of the present invention.

That which is claimed is:

1. A dual-ended torque wrench for a coaxial connector, comprising:
a body having an outer surface, a first end, a second end and an internal bore extending from the first end to the second end;
wherein the internal bore has a first hexagonal cross-section at the first end;
wherein the internal bore has a second hexagonal cross-section at the second end; and
wherein the first hexagonal cross-section is offset from the second hexagonal cross-section.

2. The dual-ended torque wrench of claim 1, wherein a middle portion of the outer surface of the body has a larger diameter than a diameter of the first end of the outer surface of the body.

3. The dual-ended torque wrench of claim 1, wherein the outer surface of the body includes a plurality of grooves.

4. The dual-ended torque wrench of claim 3, wherein the grooves comprise generally longitudinally extending grooves.

5. The dual-ended torque wrench of claim 1, wherein the outer surface of the body includes at least one labeling surface.

6. The dual-ended torque wrench of claim 1, wherein the first hexagonal cross-section is rotationally offset from the second hexagonal cross-section by between about 20 degrees to about 40 degrees.

7. The dual-ended torque wrench of claim 1, wherein the body is a two piece tubular body that includes a first body piece and a second body piece.

8. The dual-ended torque wrench of claim 7, wherein the first body piece includes a projection and the second body piece includes a receptacle that is configured to receive the projection.

9. The dual-ended torque wrench of claim 7, wherein the first body piece is in snap engagement with the second body piece, and wherein the first and second body pieces are substantially identical.

10. The dual-ended torque wrench of claim 1, wherein the body is a one piece tubular body that includes a hinge.

11. The dual-ended torque wrench of claim 1, wherein the central portion of the internal bore has a third cross-section that differs from both the first and second hexagonal cross-sections.

12. The dual-ended torque wrench of claim 1, in combination with a coaxial patch cord having a coaxial connector terminated on each end thereof.

13. A torque wrench for a coaxial connector, comprising:
a body having an outer surface, a first end, a second end and an internal bore extending from the first end to the second end;
wherein the internal bore has a first hexagonal cross-section at the first end;
wherein the internal bore has a second hexagonal cross-section at the second end; and
wherein a central portion of the internal bore has a third cross-section that is different from both the first hexagonal cross-section and the second hexagonal cross-section.

14. The torque wrench of claim 13, wherein the third cross-section comprises a substantially circular cross-section.

15. The torque wrench of claim 14, wherein the diameter of the third cross-section is at least substantially as large as the crown-to-crown diameter of the first hexagonal cross-section.

16. The torque wrench of claim 15, wherein the second hexagonal cross-section is rotationally offset from the first hexagonal cross-section.

17. The torque wrench of claim 13, wherein a middle portion of the outer surface of the body has a larger diameter than a diameter of the first end of the outer surface of the body.

18. The torque wrench of claim 17, wherein the outer surface of the body includes a plurality of generally longitudinally extending grooves.

19. The torque wrench of claim 18, wherein the body is a two piece tubular body that includes a first body piece that includes a projection and a second body piece that includes a receptacle that is configured to receive the projection.

20. The torque wrench of claim 18, wherein the body is a one piece tubular body that includes a hinge.

21. The torque wrench of claim 13, in combination with a coaxial patch cord having a coaxial connector terminated on each end thereof.

22. The torque wrench of claim 13, wherein the torque wrench comprises a dual-ended torque wrench.

23. A method of installing a coaxial patch cord that comprises a coaxial cable segment having a first coaxial connector on a first end thereof and a second coaxial connector on a second end thereof, the method comprising:
engaging a first end of a dual-ended torque wrench over a nut of the first coaxial connector;
rotating the dual-ended torque wrench and nut of the first coaxial connector to tighten the nut of the first coaxial connector;
sliding the dual-ended torque wrench axially along the coaxial cable segment to the second coaxial connector;
engaging a second end of the dual-ended torque wrench over a nut of the second coaxial connector; and
rotating the dual-ended torque wrench and nut of the second coaxial connector to tighten the nut of the second coaxial connector.

24. The method of claim 23, wherein the dual-ended torque wrench comprises a tubular body having an outer surface and an internal bore that has a first hexagonal cross-section at the first end and another portion that has a second hexagonal cross-section that is separated from and/or rotationally offset from the first hexagonal cross-section.

25. The dual-ended torque wrench of claim 1, wherein the outer surface of the body includes a plurality of stubs.
